(19) United States
(12) Patent Application Publication
(10) Pub. No.: US 2007/0171846 A1
(43) Pub. Date: Jul. 26, 2007

(54) Modeling, managing, and scheduling videoconference meetings

(76) Inventors: Chia-Hsin Li, San Jose, CA (US); Brian Chan, Palo Alto, CA (US)

Correspondence Address: EPSON RESEARCH AND DEVELOPMENT INC;INTELLECTUAL PROPERTY DEPT, 2580 ORCHARD PARKWAY, SUITE 225, SAN JOSE, CA, 95131, US

(21) Appl. No.: 11/339,934

(22) Filed: Jan. 25, 2006

(51) Int. Cl. H04L 12/16

(52) U.S. Cl. 370/260

(57) ABSTRACT

Embodiments of the present invention provide data structures for modeling videoconference meetings, including videoconference meetings having only a single occurrence and videoconference meetings that repeat regularly, such as on a weekly or monthly basis. Some embodiments additionally model videoconference meetings that are part of a repeating series, but that have been canceled or moved to a different time, day, or the like, than the other videoconference meetings in the series. Embodiments of the present invention also provide methods for managing videoconference meetings, scheduling videoconference meetings, displaying the schedules, and monitoring videoconference participant load for videoconference meetings. Some embodiments additionally model videoconference media files, and methods for managing the media files.

### BACKGROUND

The present invention relates generally to videoconferencing. More particularly, the present invention relates to modeling, managing, and scheduling videoconference meetings.

### SUMMARY

In general, in one aspect, the invention features a data structure comprising a plurality of videoconference meeting entities each representing a videoconference meeting; and a plurality of attributes for each of the videoconference meeting entities, the attributes comprising one or more schedule attributes each having a value selected from the group consisting of a scheduled start time of the respective videoconference meeting, a scheduled end time of the respective videoconference meeting, and a scheduled duration of the respective videoconference meeting, and an interval type attribute having a value selected from the group consisting of once only, indicating that the respective videoconference meeting comprises only one occurrence, repeating, indicating that the respective videoconference meeting comprises a repeating series of occurrences, and branched, indicating that the respective videoconference meeting comprises only one occurrence, and that the attributes of the respective videoconference meeting entity have the same values as the attributes of another one of the videoconference meeting entities having an interval type attribute value of repeating except for one or more of the schedule attributes.

In some embodiments, each of the videoconference meeting entities has a different meeting identifier, and each occurrence of the videoconference meetings has a different index. In such embodiments, the data structure further comprises a branch entity representing a relationship between a first one of the videoconference meeting entities having an interval type attribute value of repeating and a second one of the videoconference meeting entities having an interval type attribute value of branched; and a plurality of attributes for the branch entity, the attributes comprising a series identifier having a value representing a meeting identifier of the first one of the videoconference meeting entities, a branch identifier having a value representing a meeting identifier of the second one of the videoconference meeting entities, and an index of a videoconference meeting represented by the second one of the videoconference meeting entities.

In general, in one aspect, the invention features a method for displaying a schedule of the videoconference meetings, the method comprising: selecting a coverage period for the schedule of meetings, the coverage period comprising a plurality of intervals; and for each of the intervals in the coverage period, and each of the videoconference meeting entities having an interval type attribute value of repeating, displaying an indicator of the occurrence of the respective videoconference meeting when the occurrence of the respective videoconference meeting intersects temporally with the interval, and none of the series identifiers of the branch entities has a value representing the meeting identifier of the videoconference meeting entity representing the respective videoconference meeting. Some embodiments comprise determining whether the occurrence of the respective videoconference meeting intersects temporally with the interval, comprising at least one step selected from the group comprising determining whether the scheduled start time of the respective videoconference meeting follows an end time of the interval, and determining whether the scheduled end time of the respective videoconference meeting precedes a start time of the interval. Some embodiments comprise a medium or waveform containing a program of instructions, e.g., a computer program, for performing the method. Some embodiments comprise an apparatus to perform the method.

Some embodiments comprise a plurality of media entities each representing a link between a media file and one of the videoconference meeting entities. Some embodiments comprise a method for managing the media entities, comprising: storing one of the media files; generating a first one of the media entities representing a link between the one of the media files and a selected one of the videoconference meeting entities; and generating one or more second ones of the media entities each representing a link between the one of the media files and one of the branch entities having series identifier values representing the meeting identifier of the selected one of the videoconference meeting entities. Some embodiments comprise deleting the one of the media files when the first one of the media entities is deleted. Some embodiments comprise retaining the one of the media files when any of the second ones of the media entities are deleted. Some embodiments comprise a medium or waveform containing a program of instructions, e.g., a computer program, for performing the method. Some embodiments comprise an apparatus to perform the method.

Some embodiments comprise a plurality of invited videoconference participant entities each representing a videoconference participant invited to one of the videoconference meetings. Some embodiments comprise a method for calculating a videoconference participant load for an interval in a videoconference schedule comprising a plurality of the videoconference meetings, the method comprising: generating an array comprising, for each of the videoconference meetings having an occurrence that temporally intersects the interval, generating a first data pair comprising a first participant value representing the number of the participant entities associated with the videoconference meeting and a first difference between a reference time and the start time of the videoconference meeting, and generating a second data pair comprising a second participant value representing the negative of the number of the participant entities associated with the videoconference meeting and a second difference between the reference time and the end time of the videoconference meeting; and traversing the array in order according to the first and second differences, comprising adding the first and second participant values to a participant total. Some embodiments comprise indicating a videoconference load violation when the videoconference participant total exceeds a predetermined maximum participant total.

In general, in one aspect, the invention features a method for calculating a videoconference participant load for an interval in a videoconference schedule comprising a plurality of the videoconference meetings, the method comprising: generating an array comprising, for each of the videoconference meetings having an occurrence that temporally intersects the interval, generating a first data pair comprising a participant value representing the number of videoconference participants associated with the videoconference meeting and a first difference between a reference time and the start time of the videoconference meeting, and generating a second data pair comprising a participant value representing the negative of the number of the videoconference participants associated with the videoconference meeting and a second difference between the reference time and the end time of the videoconference meeting; and traversing the array in order according to the first and second differences, comprising adding the first and second participant values to a participant total.

Some embodiments comprise indicating a videoconference load violation when the videoconference participant total exceeds a predetermined maximum participant total. Some embodiments comprise a medium or waveform containing a program of instructions, e.g., a computer program, for performing the method. Some embodiments comprise an apparatus to perform the method.

The details of one or more implementations are set forth in the accompanying drawings and the description below. Other features will be apparent from the description and drawings, and from the claims.

### DESCRIPTION OF DRAWINGS

FIG. 1 shows a videoconference system comprising a videoconference server and a plurality of videoconference clients. Also shown is an optional media server.

FIG. 2 shows a data structure for modeling videoconferences in the videoconference system according to a preferred embodiment of the present invention.

FIG. 3 shows a process for the videoconference system for displaying a schedule of videoconference meetings according to a preferred embodiment of the present invention.

FIG. 4 shows an exemplary videoconference meeting schedule.

FIG. 5 shows a process for the videoconference system for adding media files for videoconference meetings according to a preferred embodiment of the present invention.

FIG. 6 shows a process for the videoconference system for deleting media files for videoconference meetings according to a preferred embodiment of the present invention.

FIG. 7 shows a process for the videoconference system for calculating a videoconference participant load for an interval in a videoconference schedule comprising a plurality of the videoconference meetings according to a preferred embodiment of the present invention.

FIG. 8 shows an example videoconference schedule comprising a plurality of videoconference meetings that is used to illustrate the operation of the process.

The leading digit(s) of each reference numeral used in this specification indicates the number of the drawing in which the reference numeral first appears.

### DETAILED DESCRIPTION

Embodiments of the present invention provide data structures for modeling videoconference meetings, including videoconference meetings having only a single occurrence and videoconference meetings that repeat regularly, such as on a weekly or monthly basis. Some embodiments additionally model videoconference meetings that are part of a repeating series, but that have been canceled or moved to a different time, day, or the like, than the other videoconference meetings in the series. For example, a repeating Monday videoconference meeting may occasionally be moved to the following Tuesday to accommodate a Monday holiday. Embodiments of the present invention also provide methods for managing videoconference meetings, scheduling videoconference meetings, displaying the schedules, and monitoring videoconference participant load for videoconference meetings. Some embodiments additionally model videoconference media files, for example representing charts, video clips, and the like, to be shared with videoconference meeting participants. Embodiments of the present invention also provide methods for managing the media files.

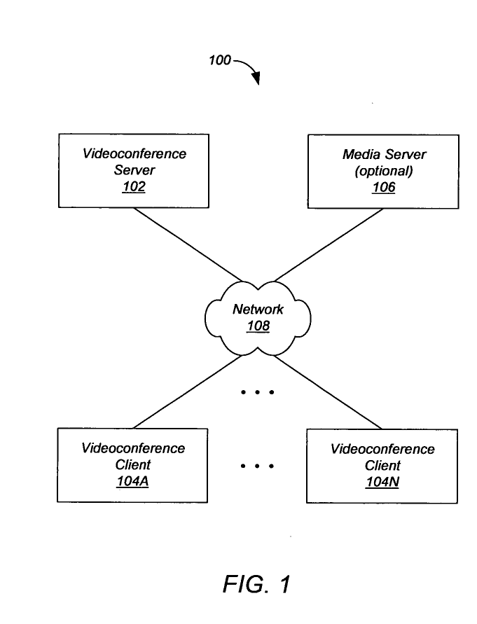

FIG. 1 shows a videoconference system 100 comprising a videoconference server 102 and a plurality of videoconference clients 104A-N. Also shown is an optional media server 106. Preferably videoconference server 102, videoconference clients 104, and optional media server 106 are connected by one or more networks 108 such as the Internet.

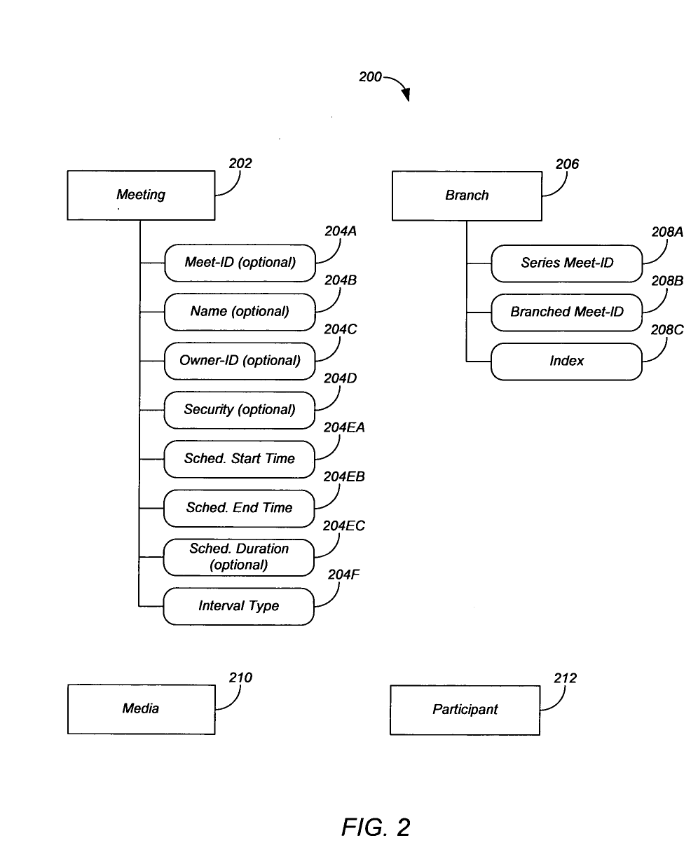

FIG. 2 shows a data structure 200 for modeling videoconferences in videoconference system 100 according to a preferred embodiment of the present invention. Data structure 200 comprises one or more videoconference meeting entities 202 each representing a videoconference meeting, and a plurality of attributes 204 for each of the videoconference meeting entities 202. Attributes 204 comprise an optional meeting identifier (Meet-ID) 204A that identifies the videoconference meeting represented by the respective videoconference meeting entity 202, an optional name attribute (Name) 204B that identifies a name of the respective videoconference meeting entity 202, an optional owner identifier attribute (Owner-ID) 204C that identifies an owner of the videoconference meeting represented by the respective videoconference meeting entity 202, an optional security attribute (Security) 204D that identifies security attributes of the videoconference meeting represented by the respective videoconference meeting entity 202, one or more schedule attributes 204E that identify a schedule of the videoconference meeting represented by the respective videoconference meeting entity 202, and an interval type attribute 204F that identifies any repetitions of the videoconference meeting represented by the respective videoconference meeting entity 202.

Schedule attributes 204E preferably comprise a scheduled start time (Sched. Start Time) 204EA that identifies a scheduled start time of the videoconference meeting represented by the respective videoconference meeting entity 202, a scheduled end time (Sched. End Time) 204EB that identifies a scheduled end time of the videoconference meeting represented by the respective videoconference meeting entity 202, and an optional scheduled duration (Sched. Duration) 204EC that identifies a scheduled duration of the videoconference meeting represented by the respective videoconference meeting entity 202.

Interval type attribute 204F preferably has a value selected from the group consisting of “once only,” indicating that videoconference meeting represented by the respective videoconference meeting entity 202 comprises only one occurrence, “repeating,” indicating that videoconference meeting represented by the respective videoconference meeting entity 202 comprises a repeating series of occurrences, and “branched,” indicating that videoconference meeting represented by the respective videoconference meeting entity 202 comprises only one occurrence, and that the attributes 204 of the respective videoconference meeting entity 202 have the same values as the attributes of another one of the videoconference meeting entities 202 having an interval type attribute value of “repeating” except for one or more of schedule attributes 204E. In some embodiments, the value of interval type attribute 204F comprises the duration of the repetition interval when it has a value of “repeating.” In other embodiments, the value of “repeating” is replaced with values representing the repetition interval, such as “daily,” “weekly,” and the like.

Occasionally it is desirable to reschedule an occurrence of a repeating videoconference meeting. Data structure 200 optionally further comprises branch entities 206 to represent the rescheduled occurrence, which is referred to herein as a “branched” videoconference meeting, and the relationship between the branched videoconference meeting and the associated repeating videoconference meeting. Referring again to FIG. 2, each branch entity 206 represents a relationship between a repeating videoconference meeting entity 202 (that is, a videoconference meeting entity 202 having an interval type attribute value of “repeating”) and a branched videoconference meeting entity 202 (that is, a videoconference meeting entity 202 having an interval type attribute value of “branched”). Data structure 200 optionally further comprises a plurality of attributes 208 for each branch entity 206. Attributes 208 comprise a series identifier (Series Meet-ID) 208A having a value representing a meeting identifier of the repeating videoconference meeting entity 202, a branch identifier (Branched Meet-ID) 208B having a value representing a meeting identifier of the branched videoconference meeting entity 202, and an index (Index) 208C of a videoconference meeting represented by the second videoconference meeting entity.

Each occurrence of the videoconference meetings represented by a videoconference entity 202 has a different index representing the order of occurrence. Tables 1 and 2 illustrate the use of the index according to a preferred embodiment of the present invention.

TABLE 1
Meetings

| | | | Sched. | Sched. End | | |
|---|---|---|---|---|---|---|
| Meet_ID | Name | Owner_ID | Start Time | Time | Security | Interval Type |
| 9 | ‘series’ | 10 | 01/28/05 | 01/28*/05 | true | weekly |
| | | | (Fri.) | (Fri.) | | |
| | | | 1:00 pm | 2:00 pm | | |
| 11 | ‘branch’ | 10 | 02/10/5 | 02/10/05 | true | branched_add |
| | | | (Thurs.) | (Thurs.) | | |
| | | | 3:00 pm | 4:00 pm | | |

TABLE 2
Branches

| Series Meet_ID | Branched Meet-ID | Index |
|---|---|---|
| 9 | 11 | 2 |

This example represents a repeating meeting having one branch. Table 1 shows the attribute values of the videoconference meeting entities 202 for the repeating videoconference meeting and the branched videoconference meeting. Referring to Table 1, the repeating meeting has a meeting identifier of 9, and the branched meeting has a meeting identifier of 11. The repeating videoconference meeting occurs every Friday from 1:00 p.m.-2:00 p.m., beginning on Jan. 28, 2005. The branched videoconference meeting attributes show that the third occurrence of the repeating videoconference meeting has been moved to the preceding Thursday.

Table 2 shows the attribute values for the branch entity 206 representing the relationship between the repeating videoconference meeting and the branched videoconference meeting. Referring to Table 2, the branch entity 208 has a series meeting identifier of 9 that identifies the repeating meeting in Table 1, a branched meeting identifier of 11 that represents the branched meeting in Table 1, and an index of two, which shows that the branched meeting is the third occurrence (because the first index value is zero) of the repeating meeting.

Occasionally it is desirable to cancel an occurrence of a repeating videoconference meeting. Preferably a branched videoconference meeting entity 202 having an interval type attribute value of “branched_removed” is used to represent canceled occurrences of a repeating videoconference meeting.

Occasionally videoconference participants find it is desirable to share media files such as charts, video clips, and the like. Data structure 200 optionally further comprises media entities 210 each representing a link between a media file and a videoconference meeting entity 202. Referring again to FIG. 1, the media files are preferably stored on optional media server 106.

Data structure 200 also optionally includes participant entities 212 each representing a participant of one or more of the videoconference meetings represented by videoconference meeting entities 202.

Embodiments of the present invention provide a method for displaying a schedule of videoconference meetings for a coverage period comprising one or more intervals. In general, for each of the intervals in the coverage period, and each of the videoconference meeting entities 202 having an interval type attribute value of repeating, the method displays an indicator of the occurrence of the respective videoconference meeting when the occurrence intersects temporally with the interval, and is not a branch of the repeating videoconference meeting (that is, none of the series identifiers of the branch entities 206 has a value representing the meeting identifier of the videoconference meeting entity 202 representing the respective videoconference meeting). The pseudo-code that follows presents one implementation of the method.

```
For every interval
If (meeting repeats) {
  Calculate the closest index of the repeating series to the day
  If (a branch for the index exists) {
    Do not show the meeting;
    Return;
} else {
if (meeting intersect with the interval) {
    Show the meeting;
    Return;
  }
}
} else {
  if (meeting's interval type is not BRANCH_REMOVE) {
    if (meeting intersect with the interval) {
      Show the meeting;
      Return;
    }
  }
}
Do not show the meeting;
Return;
```

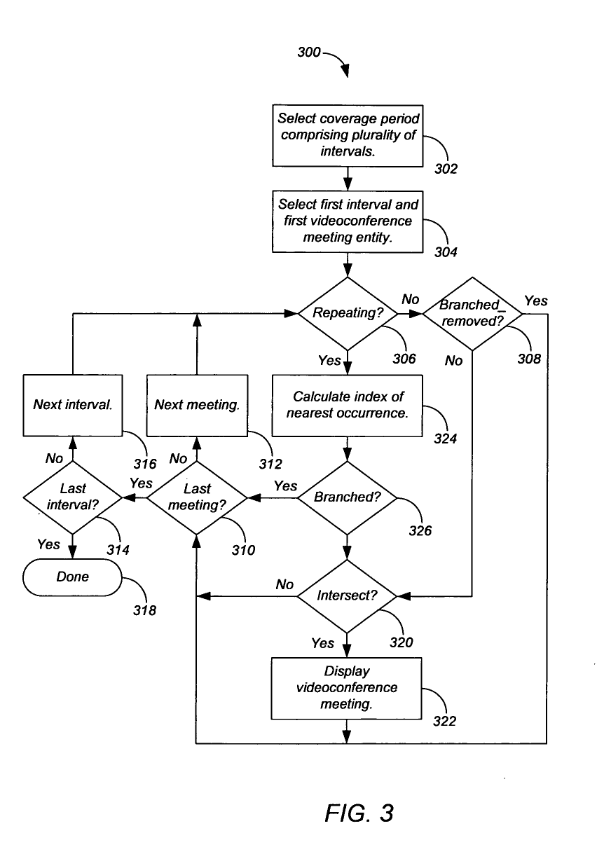

FIG. 3 shows a process 300 for videoconference system 100 for displaying a schedule of videoconference meetings according to a preferred embodiment of the present invention. Process 300 selects a coverage period for the schedule of meetings, the coverage period comprising a plurality of intervals (step 302). For example, the coverage period can be one day, and each interval can be one hour.

Process 300 then selects the first interval of the coverage period and a first one of the videoconference meeting entities 202 (step 304). If the selected videoconference meeting entity 202 does not have an interval attribute type value of “repeating” (step 306), but instead has an interval attribute type value of “branched-removed” (step 308), then if the selected videoconference meeting entity 202 is not the last videoconference meeting entity 202 (step 310), then process 300 selects the next videoconference meeting entity 202 (step 312) and resumes at step 306. But if at step 310 the selected videoconference meeting entity 202 is the last videoconference meeting entity 202, and the selected interval is not the last interval in the coverage period (step 314), then process 300 selects the next interval (step 316) and resumes at step 306. But if at step 314 the selected interval is the last interval in the coverage period, then process 300 is done (step 318).

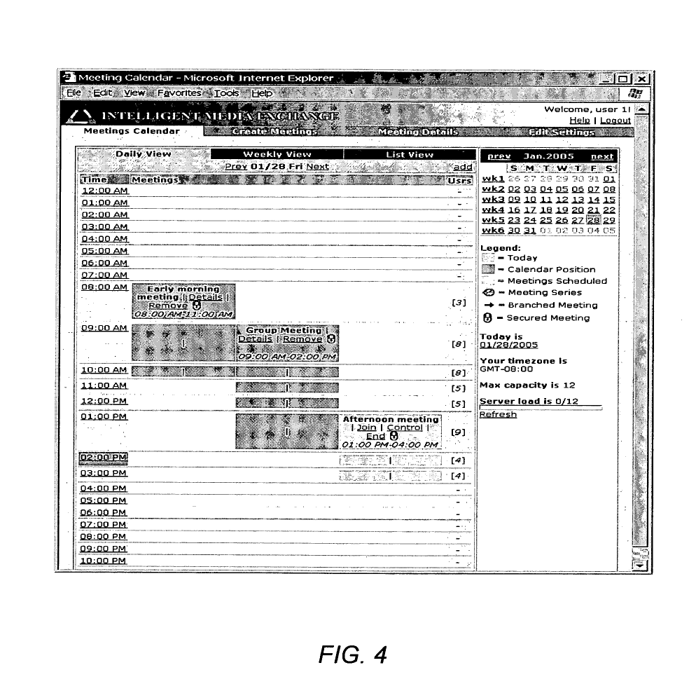

But if at step 308 the selected videoconference meeting entity 202 does not have an interval attribute type value of “branched-removed” (indicating the value is either “once only” or “branched”) and intersects temporally (that is, overlaps in time) with the selected interval (step 320), then process 300 displays the videoconference meeting (step 322), for example on a meeting schedule such as that shown in FIG. 4. Otherwise process 300 resumes at step 310.

In general, to determine whether an occurrence of a videoconference meeting intersects temporally with the interval, process 300 determines whether the scheduled start time of the videoconference meeting follows the end time of the interval, and determines whether the scheduled end time of the videoconference meeting precedes the start time of the interval. If either condition is true, there is no intersection. The pseudo-code that follows presents one implementation of the method.
tmIntervalStart=the specified time in long integer since 1970 0:0:0 AM GMT-0:0.
tmIntervalEnd=tmIntervalStart+1 interval−1 millisecond
tmSST=the meeting's scheduled start time
tmSET=the meeting's scheduled end time
if (tmIntervalEnd<tmSST or tmIntervalStart>tmSET) return false;
return true;

Referring again to FIG. 3, if at step 306 the selected videoconference meeting entity 202 has an interval type attribute value of “repeating,” process 300 calculates the index of the occurrence of the repeating meeting represented by the selected videoconference meeting entity 202 that is closest in time to the selected interval (step 324). The pseudo-code that follows presents one implementation of a method for calculating the index given the meeting identifier mt and the current time,

```
  int getSeriesIndex(Meeting mt, long tmTime) {
  int seriesIndex = 0;
    // Fix the time to the end of the day
    long tmEndOfDay = The last milli-second of the day specified by
tmTime
    // Calculate the interval
    long interval = −1;
    switch (mt.getIntervalType( )) {
      case ONCE_ONLY:
      case BRANCH_ADD:
      case BRANCH_REMOVE:
        interval = −1;
        break;
      case DAILY:
        interval = DAY_INTERVAL;
        break;
      case WEEKLY:
        interval = 7 * DAY_INTERVAL;
        break;
    }
    // Calculate the index
    if (interval < 0) {
      seriesIndex = 0;
    } else {
      long distance = tmEndOfDay − mt.getSchedStartTime( );
      seriesIndex = (int) (distance / interval);
    }
        return seriesIndex;
  }
```

If the videoconference meeting entity 202 identified by the index obtained at step 324 has an interval type attribute value of “branched” (step 326), then process 300 continues at step 310. Otherwise, process 300 continues at step 320.

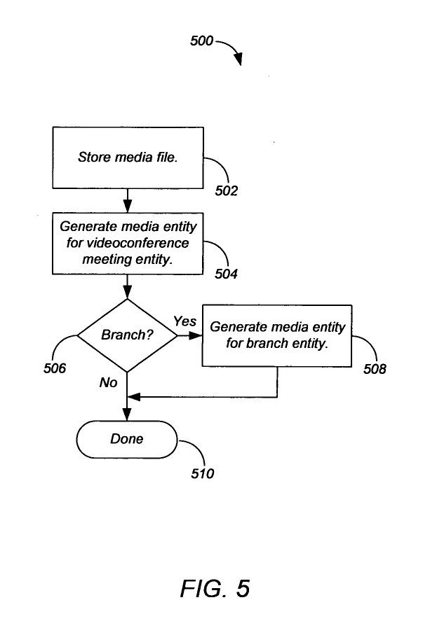

Embodiments of the present invention provide a method for managing media files for videoconference meetings according to a preferred embodiment of the present invention. FIG. 5 shows a process 500 for videoconference system 100 for adding media files for videoconference meetings according to a preferred embodiment of the present invention. In general, the media files are provided by one of the videoconference meeting participants, but may also originate elsewhere. Process 500 stores the media files (step 502), preferably on optional media server 106. Process 500 generates one or more media entities 210 each representing a link between one of the media files and one of videoconference meeting entities 202 (step 504). If a videoconference meeting entity represents a repeating meeting having one or more branches (step 506), then process 500 generates one or more media entities 210 each representing a link between the media file and one of the branch entities 206 of the repeating meeting (step 508) and is done (step 510). Otherwise process 500 is done (step 510). Branch entities 206 related to the repeating meeting can be identified by having series identifier values representing the meeting identifier of the videoconference meeting entity 202 representing the videoconference meeting.

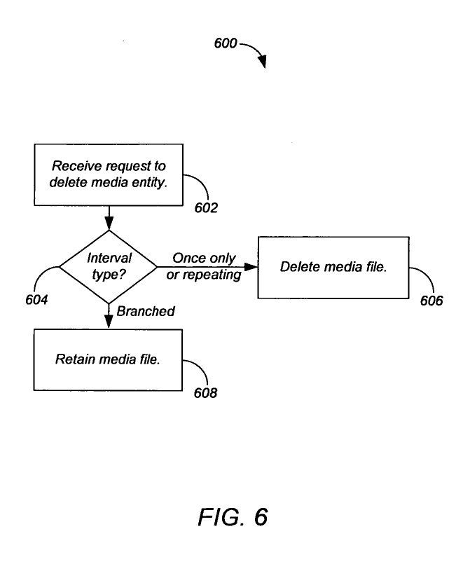

FIG. 6 shows a process 600 for videoconference system 100 for deleting media files for videoconference meetings according to a preferred embodiment of the present invention. Process 600 receives a request to delete a media entity 210 (step 602), for example because the corresponding videoconference meeting entity 202 has been deleted. The corresponding media file can be deleted or retained according to one or more media file retention rules. For example, when the corresponding videoconference meeting entity 202 represents a once only or repeating meeting (step 604), the media file is deleted (step 606) because all occurrences of the corresponding videoconference meeting have been deleted. But if at step 604 the corresponding videoconference meeting entity 202 represents a branched meeting, the media file is retained (step 608) because the corresponding repeating meeting has not been deleted, and so has one or more remaining occurrences that could require the media file.

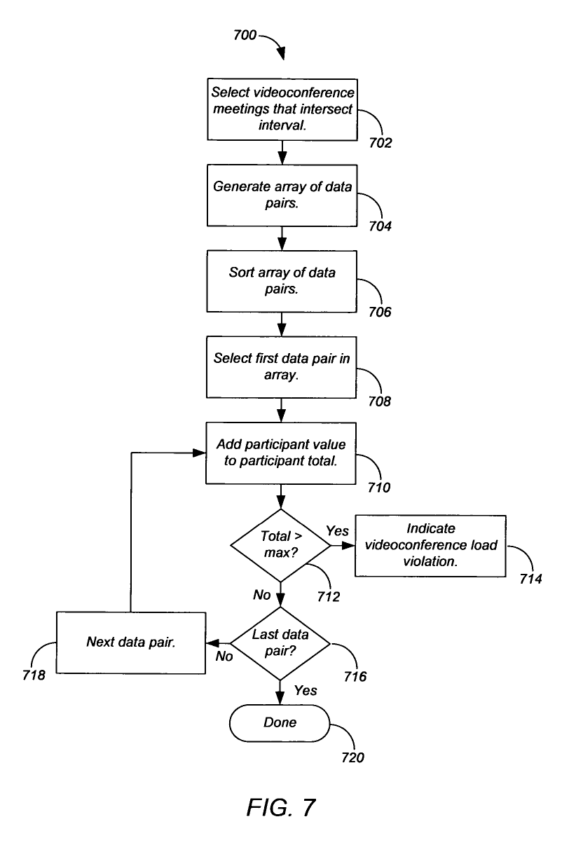

FIG. 7 shows a process 700 for videoconference system 100 for calculating a videoconference participant load for an interval in a videoconference schedule comprising a plurality of the videoconference meetings according to a preferred embodiment of the present invention. Some embodiments of process 700, such as the embodiment described below, employ data structure 200 of FIG. 2, while others do not, as will be apparent to one skilled in the relevant arts after reading this description.

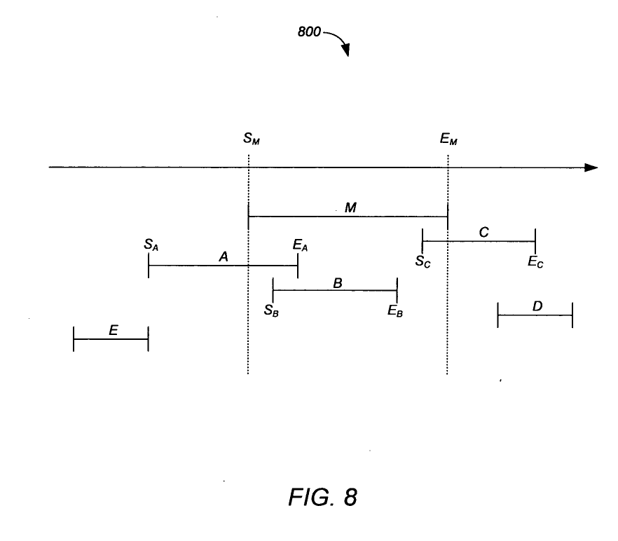

FIG. 8 shows an example videoconference schedule 800 comprising a plurality of videoconference meetings A, B, C, D, E, and M that is used to illustrate the operation of process 700 of FIG. 7. The participant load calculation interval is depicted as two vertical lines, one at the start time SM, and the other at the end time, E_{M}, of the interval. Note that the interval coincides with videoconference meeting M. This is the case, for example, when determining whether the addition of meeting M to the videoconference schedule would cause a videoconference participant load violation.

Process 700 selects only those videoconference meetings that temporally intersect the interval (step 702). Therefore videoconference meetings D and E are discarded from the load calculation.

Process 700 then generates an array comprising two data pairs for each of the selected videoconference meetings (step 704). The first data pair comprises a first participant value representing the number of the participant entities 212 associated with the videoconference meeting and the start time of the videoconference meeting, which is preferably represented as the difference between a reference time and the start time of the videoconference meeting, for example as a number of milliseconds based on a selected time in the past. The second data pair comprises a second participant value representing the negative of the number of the participant entities 212 associated with the videoconference meeting and the end time of the videoconference meeting, which is preferably represented as the difference between the reference time and the end time of the videoconference meeting. The resulting array for the example of FIG. 8 is shown below as Table 3.

TABLE 3

| | | | | | | | |
|---|---|---|---|---|---|---|---|
| S_{A}, P_{A} | E_{A}, −P_{A} | S_{B}, P_{B} | E_{B}, −P_{B} | S_{C}, P_{C} | E_{C}, −P_{C} | S_{M}, P_{M} | E_{M}, |
| | | | | | | | −P_{M} |

Process 700 then traverses the array in time order according to the start and end times, preferably by first sorting the array (step 706), then traversing the array in order from the earliest time to the latest. The sorted array is shown below as Table 4.

TABLE 4

| | | | | | | | |
|---|---|---|---|---|---|---|---|
| S_{A}, P_{A} | S_{M}, P_{M} | S_{B}, P_{B} | E_{A}, −P_{A} | E_{B}, −P_{B} | S_{C}, P_{C} | E_{M}, | E_{C}, −P_{C} |
| | | | | | | −P_{M} | |

Process 700, as it traverses the array, adds the participant values, one at a time, to a participant total. If at any time the participant total exceeds a predetermined maximum participant total, process 700 indicates a videoconference load violation.

In particular, process 700 selects the first data pair in the array (step 708) and adds the participant value in the data pair to the participant total (step 710), which is preferably set to zero at the beginning of process 700. If the participant total then exceeds the predetermined maximum participant total (step 712), process 700 indicates a videoconference load violation (step 714).

But if at step 712 the participant total does not exceed the predetermined maximum participant total, and the last data pair in the array has not been processed (step 716), process 700 selects the next data pair in the array (step 718) and resumes at step 710. But if at step 716 the last data pair in the array has been processed, process 700 is done (step 720). The pseudo-code that follows presents one implementation of the method.

```
  boolean isServerLoadExceeded(int maxConnections, long startTime,
long endTime, int initialCount) {
    Vector vMeetings = query for all meetings;
    Vector vLoadCounts = new Vector( );
    for ( each meeting m in vMeetings ) {
      int numParts = number of participants in meeting m;
      if ( m intersects with startTime and endTime) {
        vLoadCounts.addElement(new LoadCount(meeting m's
startTime, numParts));
        vLoadCounts.addElement(new LoadCount(meeting m's
endTime, − numParts));
  }
  }
  vLoadCounts.sort( ); // sort vLoadCounts according to the time field;
  int partsCount = initialCount;
  for ( each loadCount in vLoadCounts ) {
    partsCount += loadCount.partCount;
    if (partsCount > maxConnections) {
      return true;
  }
  }
  return false;
  }
```

Where a LoadCount stores a pair of attributes long_time and int-partCount

Of course, some of the videoconference meetings may be repeating meetings, as described above. For each repeating meeting, process 700 determines whether any of the occurrences of the repeating meeting intersects temporally with the interval, and selects those that intersect for inclusion in the load calculation. The pseudo-code that follows presents one implementation of the method.

```
  boolean isServerLoadExceeded(int maxConnections, long startTime,
long endTime, int initialCount) {
    Vector vMeetings = query for all meetings;
    Vector vLoadCounts = new Vector( );
    Vector vMeetingSeries = new Vector( );
    for ( each meeting m in vMeetings ) {
      int numParts = number of participants in meeting m;
      if ( m is not a repeating meeting, i.e. the interval type is not
daily or weekly... ) {
        if ( m intersects with startTime and endTime) {
          vLoadCounts.addElement(new LoadCount(meeting
m's startTime, numParts));
          vLoadCounts.addElement(new LoadCount(meeting
m's endTime, −numParts));
  }
  } else {
    vMeetingSeries.addElement(m);
  }
  }
  for ( each meeting series m in vMeetingSeries ) {
    int numParts = number of participants in meeting series m;
    int startIndex = get closest occurrence index of meeting series m to
startTime;
    int endIndex = get closest occurrence index of meeting series m to
endTime;
    for ( each occurrence j, from startIndex to endIndex of meeting series
m ) {
      if (no branch exists at j) {
      int numParts = number of participants in meeting m;
      if ( o intersects with startTime and endTime ) {
      vLoadCounts.addElement(new LoadCount( startTime at
occurrence j, numParts);
      vLoadCounts.addElement(new LoadCount( endTime at
occurrence j, −numParts);
      }
  }
  }
  vLoadCounts.sort( ); // sort vLoadCounts according to the time field;
  int partsCount = initalCount;
  for ( each loadCount in vLoadCounts ) {
    partsCount += loadCount.partCount;
    if (partsCount > maxConnections) {
      return true;
  }
  }
  return false;
  }
```

The invention can be implemented in digital electronic circuitry, or in computer hardware, firmware, software, or in combinations of them. An apparatus of the invention can be implemented in a computer program product embodied in a machine-readable storage medium or device for execution by a programmable processor; and method steps of the invention can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage mediums or devices for storing data files; such devices include magnetic disks, such as internal hard disks and removable disks; magneto-optical disks; and optical disks. Storage devices suitable for embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. A waveform, e.g., a carrier wave may also serve as a storage medium for containing program instructions. Program instructions may also be supplemented by, or incorporated in, ASICs (application-specific integrated circuits).

A number of implementations of the invention have been described. Nevertheless, it will be understood that various modifications may be made without departing from the spirit and scope of the invention. Accordingly, other implementations are within the scope of the following claims.

What is claimed is:

1. A data structure, comprising:
a plurality of videoconference meeting entities each representing a videoconference meeting; and
a plurality of attributes for each of the videoconference meeting entities, the attributes comprising
one or more schedule attributes each having a value selected from the group consisting of
a scheduled start time of the respective videoconference meeting,
a scheduled end time of the respective videoconference meeting,
a scheduled duration of the respective videoconference meeting, and an interval type attribute having a value selected from the group consisting of
once only, indicating that the respective videoconference meeting comprises only one occurrence,
repeating, indicating that the respective videoconference meeting comprises a repeating series of occurrences, and
branched, indicating that the respective videoconference meeting comprises only one occurrence, and that the attributes of the respective videoconference meeting entity have the same values as the attributes of another one of the videoconference meeting entities having an interval type attribute value of repeating except for one or more of the schedule attributes.

2. The data structure of claim 1, wherein each of the videoconference meeting entities has a different meeting identifier, and wherein each occurrence of the videoconference meetings has a different index, further comprising:
a branch entity representing a relationship between a first one of the videoconference meeting entities having an interval type attribute value of repeating and a second one of the videoconference meeting entities having an interval type attribute value of branched; and
a plurality of attributes for the branch entity, the attributes comprising
a series identifier having a value representing a meeting identifier of the first one of the videoconference meeting entities,
a branch identifier having a value representing a meeting identifier of the second one of the videoconference meeting entities, and
an index of a videoconference meeting represented by the second one of the videoconference meeting entities.

3. A method for displaying a schedule of the videoconference meetings, which includes the data structure of claim 2, the method comprising:
selecting a coverage period for the schedule of meetings, the coverage period comprising a plurality of intervals; and
for each of the intervals in the coverage period, and each of the videoconference meeting entities having an interval type attribute value of repeating, displaying an indicator of the occurrence of the respective videoconference meeting when the occurrence of the respective videoconference meeting intersects temporally with the interval, and none of the series identifiers of the branch entities has a value representing the meeting identifier of the videoconference meeting entity representing the respective videoconference meeting.

4. The method of claim 3, further comprising:
determining whether the occurrence of the respective videoconference meeting intersects temporally with the interval, comprising at least one step selected from the group comprising
determining whether the scheduled start time of the respective videoconference meeting follows an end time of the interval, and
determining whether the scheduled end time of the respective videoconference meeting precedes a start time of the interval.

5. A medium or waveform containing a program of instructions adapted to perform the method of claim 3.

6. An apparatus to perform the method of claim 3.

7. The data structure of claim 2, further comprising:
a plurality of media entities each representing a link between a media file and one of the videoconference meeting entities.

8. A method for managing media entities, which includes the data structure of claim 2, the media entities each representing a link between a media file and one of the videoconference meeting entities, the method comprising:
storing one of the media files;
generating a first one of the media entities representing a link between the one of the media files and a selected one of the videoconference meeting entities; and
generating one or more second ones of the media entities each representing a link between the one of the media files and one of the branch entities having series identifier values representing the meeting identifier of the selected one of the videoconference meeting entities.

9. The method of claim 8, further comprising:
deleting the one of the media files when the first one of the media entities is deleted.

10. The method of claim 8, further comprising:
retaining the one of the media files when any of the second ones of the media entities are deleted.

11. A medium or waveform containing a program of instructions adapted to perform the method of claim 8.

12. An apparatus to perform the method of claim 8.

13. The data structure of claim 1, further comprising:
a plurality of invited videoconference participant entities each representing a videoconference participant invited to one of the videoconference meetings.

14. A method for calculating a videoconference participant load for an interval in a videoconference schedule, which includes the data structure of claim 13, the method comprising:
generating an array comprising, for each of the videoconference meetings having an occurrence that temporally intersects the interval,
generating a first data pair comprising a first participant value representing the number of the participant entities associated with the videoconference meeting and a first difference between a reference time and the start time of the videoconference meeting, and
generating a second data pair comprising a second participant value representing the negative of the number of the participant entities associated with the videoconference meeting and a second difference between the reference time and the end time of the videoconference meeting; and
traversing the array in order according to the first and second differences, comprising adding the first and second participant values to a participant total.

15. The method of claim 14, further comprising:
indicating a videoconference load violation when the videoconference participant total exceeds a predetermined maximum participant total.

16. A method for calculating a videoconference participant load for an interval in a videoconference schedule comprising a plurality of the videoconference meetings, the method comprising:
generating an array comprising, for each of the videoconference meetings having an occurrence that temporally intersects the interval,
generating a first data pair comprising a first participant value representing the number of videoconference participants associated with the videoconference meeting and a first difference between a reference time and the start time of the videoconference meeting, and
generating a second data pair comprising a second participant value representing the negative of the number of the videoconference participants
associated with the videoconference meeting and a second difference between the reference time and the end time of the videoconference meeting; and
traversing the array in order according to the first and second differences, comprising adding the first and second participant values to a participant total.

17. The method of claim 16, further comprising:
indicating a videoconference load violation when the videoconference participant total exceeds a predetermined maximum participant total.

18. A medium or waveform containing a program of instructions adapted to perform the method of claim 16.

19. An apparatus to perform the method of claim 16.
